(19) United States
(12) Patent Application Publication
(10) Pub. No.: US 2011/0058398 A1
(43) Pub. Date: Mar. 10, 2011

(54) POWER CONVERTER SYSTEM AND METHOD

(75) Inventors: Kodjo AGBOSSOU, Trois-Rivieres (CA); Remy SIMARD, Trois-Rivieres (CA); Mylene ROBITAILLE, Trois-Rivieres (CA)

(73) Assignee: UNIVERSITE DU QUEBEC A TROIS-RIVIERES, Trois-Rivieres (CA)

(21) Appl. No.: 12/877,171

(22) Filed: Sep. 8, 2010

Related U.S. Application Data
(60) Provisional application No. 61/240,992, filed on Sep. 9, 2009.

(51) Int. Cl. H02M 7/5383

(52) U.S. Cl. 363/74

(57) ABSTRACT

An electrical power conversion system and method for connecting an electrical power source to an electrical grid, the system comprises an input module for generating a high voltage DC power signal from a variable low DC power signal of the electrical power source based on a voltage command. The system further comprises an output module connected to the high voltage DC power signal for generating an AC power signal with a peak voltage based on said voltage command according to a frequency command and a phase command. The system further comprises an electrical grid interface for selectively connecting said AC power signal to the electrical grid and to measure an electrical grid waveform for generating an electrical grid measurement including voltage, phase and frequency. The system also comprises a controller for determining an available power at said low DC power signal to allow said input module to supply said high voltage DC power signal, and also for setting said phase command, said voltage command and said frequency command based on said electrical grid measurement.

### TECHNICAL FIELD

The present invention relates to an electrical power conversion system and method and, more particularly, to an electrical power conversion system and method for converting electrical power generated from various types of power sources and for transferring a converted electrical power into an electrical grid.

### BACKGROUND

In many industrialized countries a growing need for energy is being sensed and decision makers are looking towards supplying energy made from renewable sources such as renewable electrical power sources. There are several types of renewable electrical power source that have been perfected over the years, such as photovoltaic arrays that transform solar energy into electrical power and wind turbines that transform wind energy into electrical power. For transferring electrical power to an end user device, these electrical power sources are connected to an electrical grid which transports electrical power to various power consumption sites.

The electrical power already present in the electrical grid follows a certain waveform, and for transferring electrical power into the grid a compatible waveform must be produced by the electrical power source. However, the waveform within the electrical grid can vary depending on various conditions such as the amount of power generated by the connected electrical power sources and the amount of power drawn from the loads that are connected to the electrical grid. Moreover, these renewable electrical power sources do not generate a constant amount of electrical power and the amount of electrical power generated depends on the type of electrical power source.

The electrical power generated from each electrical power source is in the form of a DC (direct current). The electrical grid however only accepts an AC (alternating current) waveform having a given voltage and given frequency. For being accepted into the electrical grid, the DC must be converted into a compatible AC power signal. For doing so, it is common practice to convert the voltage of the DC into a desired voltage using a DC/DC converter. Once converted into the desired voltage, the converted DC is then inverted into a desired AC power signal using a DC/AC inverter.

In U.S. Pat. No. 5,077,652 there is disclosed a DC to AC converter that is connected to a load. This converter uses a DC/DC converter to boost an input DC from a low voltage to a higher voltage. The output of the DC/DC converter is connected to a DC/AC inverter, the inverter inverts the generated higher voltage DC into an AC power signal having a desired frequency. The DC/DC converted is connected to a controller module that controls the converter based on a voltage feedback from the output of the DC/DC converter, the controller module regulates the output voltage of the converter based on a predetermined voltage.

However the voltage at the output of the DC/DC converter cannot be adjusted to the waveform variations in the electrical grid. Also, the available power cannot efficiently be converted into an AC power signal when the DC input power fluctuates.

Moreover, in the disclosed DC to AC converter there is no way to verify if the electrical grid is operational and if the converter should feed the electrical grid with electrical power. In the case of an un-operational electrical grid such as during a power blackout, the electrical grid operators have no control over the various power sources that are connected to the electrical grid. If the power sources keep on feeding an un-operational electrical grid, an electrical grid islanding situation will occur and this can result into a hazardous situation, affecting the security of maintenance personal and damaging electrical network devices or even damaging end user devices that are connected to the electrical grid.

Consequently an efficient way of adjusting the generated AC power signal to the varying waveform of the electrical grid and the varying DC input power would be advantageous to minimize energy losses. Moreover, a safer way of feeding electrical power into the electrical grid by various distributed power sources is required to prevent hazardous situations.

### SUMMARY

According to one aspect of the invention, there is provided an electrical power conversion system for connecting an electrical power source to an electrical grid that can draw more electrical power than the electrical power source can provide comprising an input module for generating a high voltage DC power signal from a variable low DC power signal of the electrical power source based on a voltage command, an output module connected to the high voltage DC power signal for generating an AC power signal with a peak voltage based on the voltage command according to a frequency command and a phase command, an electrical grid interface for selectively connecting the AC power signal to the electrical grid and to measure an electrical grid waveform for generating an electrical grid measurement including voltage, phase and frequency, and a controller for determining an available power at the low DC power signal to allow the input module to supply the high voltage DC power signal, for setting the phase command with respect to grid phase measured by the electrical grid interface in accordance with the available power, for setting the voltage command based on grid voltage measured by the electrical grid interface, for setting the frequency command based on grid frequency measured by said electrical grid interface and for detecting loss of the electrical grid to control the grid interface to disconnect the AC power signal from said electrical grid.

### BRIEF DESCRIPTION OF THE DRAWINGS

The invention will be better understood by way of the following detailed description of embodiments of the invention with reference to the appended drawings, in which:

FIG. 1A is a block diagram of an electrical power conversion system for connecting a power source to an electrical grid where a high DC power signal voltage measurement is used to determine an input power information, according to an embodiment;

FIG. 1B is a block diagram of an electrical power conversion system for connecting a power source to an electrical grid where a voltage command is used to determine an input power information, according to an embodiment;

FIG. 2A is a flow chart of an electrical power conversion method for connecting a power source to an electrical grid where a high DC power signal voltage measurement is used to determine an input power information, according to an embodiment;

FIG. 2B is a flow chart of an electrical power conversion method for connecting a power source to an electrical grid where a voltage command is used to determine an input power information, according to an embodiment;

FIG. 3A is a block diagram of an input module of the system having a low DC power signal as input and where a voltage command is received by an AC generator, according to an embodiment;

FIG. 3B is a block diagram of an input module of the system having a high DC power signal as input and where a voltage command is received by an AC generator, according to an embodiment;

FIG. 3C is a block diagram of an input module of the system where a voltage command is received by a voltage regulator of a low AC power signal, according to an embodiment;

FIG. 3D is a block diagram of an input module of the system where a voltage command is received by a transformer, according to an embodiment;

FIG. 4 is a block diagram of an output module of the system where a voltage command, phase offset command and a frequency command are received by a sine wave generator, according to an embodiment;

FIG. 5A is a block diagram of an interface module according to an embodiment;

FIG. 5B is a graph representing a phase displacement between an AC output waveform and a grid waveform;

FIG. 5C is a graph representing a stretched zero crossing of the AC output waveform for detecting an islanding situation of the electrical grid;

FIG. 5D is a graph representing a truncated voltage of the AC output waveform for detecting an islanding situation of the electrical grid;

FIG. 6 is a block diagram of three converters being synchronized for generating a three phase AC output; and

FIG. 7 is a block diagram of the system connectable to a configuration manager, according to an embodiment.

### DETAILED DESCRIPTION

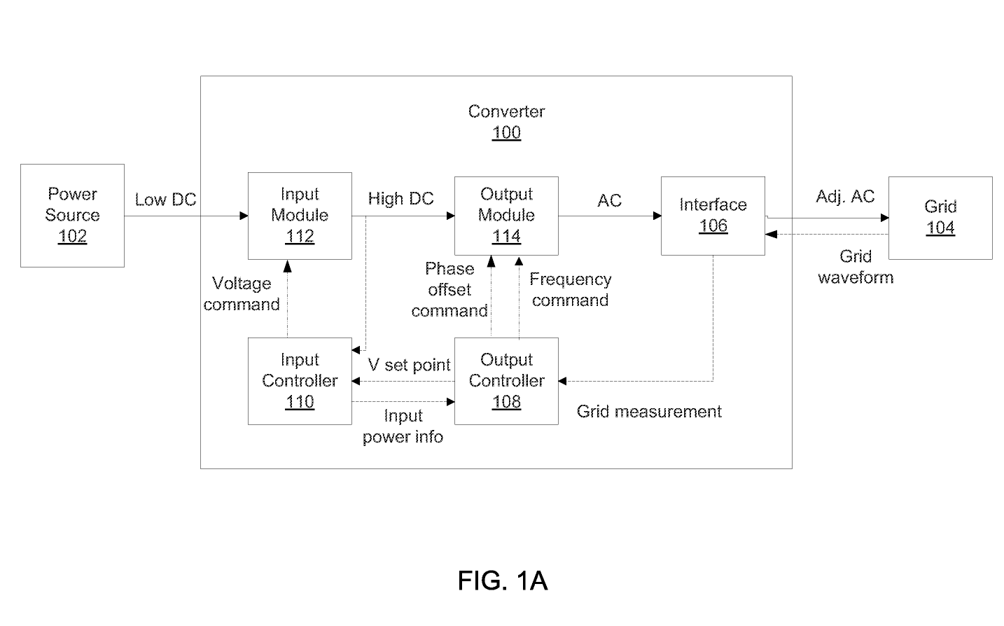

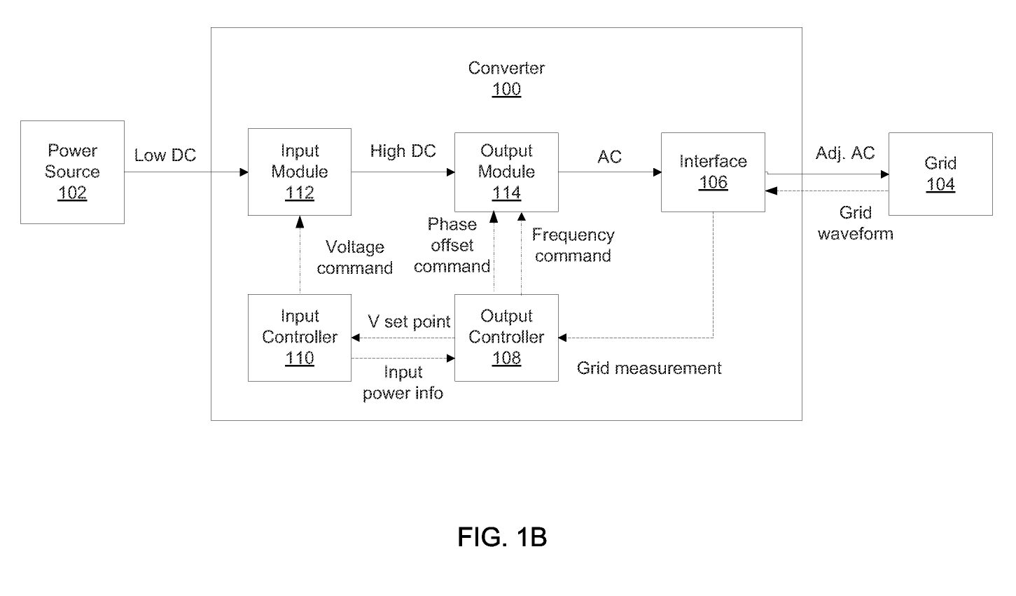

Presented in FIG. 1A is an electrical power conversion system 100 that is depicted as being adapted to connect to a power source 102 such as a wind turbine or a photovoltaic array and to connect to an electrical grid 104. Once connected to the power source 102 and the electrical grid 104, this system 100 is able to transfer power from the power source 102 into the electrical grid 104. In general, the electrical grid 104 can retrieve more power than the power source 102 can provide and the amount of power that the power source 102 can generate is normally variable. Depending on various environmental conditions such as wind speed in the case of a wind turbine or light units in the case of a photovoltaic array, the amount of power the power source 102 is able to generate varies. For this reason, the system 100 is able to adapt to the power generated by the power source 102 and efficiently convert this power into a waveform that is compatible with the electrical grid 104. Although in this embodiment the system 100 is adapted to connect to a power source 102 that retrieves energy from a wind turbine or a photovoltaic array, it will be understood by a skilled person that the system 100 is also adapted to connect to a power source 102 of any other type that retrieves energy from either a renewable or a non-renewable power source.

According to an embodiment, the system 100 is adapted to dynamically generate an AC power signal having a waveform that is compatible with the waveform of the electrical grid 104. The system 100 draws a variable low DC power signal directly from the power source 102 or from a battery that has been charged by the power source 102. The system 100 then converts this low DC power signal into an AC power signal having a waveform that is compatible with the waveform of the electrical grid 104. Before generating the AC power signal, the waveform of the electrical grid 104 is first analyzed for detecting variations. The waveform of the electrical grid 104 is variable as the amount of power transferred into the electrical grid 104 from the connected power sources 102 is variable and as the amount of power drawn by the loads from the electrical grid 104 is also variable. Although the system 100 described herein is adapted to connect to a power source that generates a variable low DC power signal, it will be understood by a skilled person that it is possible for this system 100 to connect to a power source that generates a power signal that has a higher voltage than that of the waveform of the electrical grid 104. In such a case, the system 100 converts a high DC power signal into an AC power signal having a waveform that is compatible with the waveform of the electrical grid 104 by voltage down conversion.

Moreover, as electrical power transportation standards can differ from one country or region to another, the acceptable waveform range on the electrical grid can also differ. According to an embodiment, the system 100 is adapted to dynamically generate a waveform that is compatible to either one of the various electrical standards such as: 120V at 50 Hz/60 Hz, 240V at 50 Hz/60 Hz, 550V at 50 Hz/60 Hz, etc.

To do this, as further presented in FIG. 1A, the system 100 comprises an electrical grid interface 106, an output controller 108, an input controller 110, an input module 112 and an output module 114. The interface 106 is a point of connection between the system 100 and the electrical grid 104, it allows analyzing the grid's waveform and providing grid waveform information to the other components of the system 100. The output controller 108 receives the grid waveform information as an electrical grid measurement. From the grid measurement, it is possible for the output controller 108 to determine a voltage set point, a frequency set point and a phase set point each set point being based on a corresponding parameter of the grid waveform. For example, if the waveform of the grid is of 120V at 60 Hz with a 10 degree phase, the voltage set point, the frequency set point and the phase set point would be fixed accordingly. These set points are used as a guideline for the system 100 for generating an AC power signal that can be transferred into the electrical grid 104 while minimizing power loss.

According to one embodiment, the output controller 108 sends the voltage set point to the input controller 110. Based in part on this voltage set point, the input controller 110 generates a voltage command for the input module 112. The input module 112 is the entry point of the low DC power signal generated by the power source 102. Based on the voltage command, the input module 112 generates a high DC power signal for sending to the output module 114.

Depending in part on the amount of power available and in part on the voltage command, the voltage of the generated high DC power signal varies. For obtaining a high DC power signal having the desired voltage, the voltage command must be adjusted to the power available. According to one embodiment, the system 100 has a feedback loop of the high DC power signal voltage measurement. Based on this measurement, the input controller 110 adjusts the voltage command which is a duty cycle command for the input module 112 to maintain, increase or decrease the voltage of the high DC power signal.

Based on the high DC power signal voltage measurement, according to one embodiment of the system 100, the input controller 110 is adapted to monitor the current of the high DC power signal and limits the current when the current is higher than a given threshold.

According to another embodiment, based on the high DC power signal voltage measurement, the input controller 110 generates an input power info for the output controller 108. The input power info holds information concerning the available power generated by the power source 102 at the low DC power signal. It will be understood by a skilled person that the input power info can also be generated based on a low DC power signal voltage measurement.

According to one embodiment, the output controller 108 determines a phase offset command based in part on the input power info. In a case where the available power is too low and the system 100 is unable to generate a high DC power signal with the desired voltage, the output controller 108 determines a phase offset command to generate an AC power signal having a current that is high enough to transfer the available amount of power into the electrical grid 104. The output controller 108 determines the phase offset command also based in part on the phase set point so that the output module 114 generates an AC power signal that is in phase with the grid's waveform.

Similarly, the output controller 108 determines the frequency command based on the frequency set point so that the output module 114 generates an AC power signal that has a same frequency as the grid's waveform. Once determined, both the phase offset command and the frequency command are sent to the output module 114, the output module 114 in turn is adapted to receive the high DC power signal and to process it based on the phase offset command and the frequency command for generating the AC power signal.

According to another embodiment, the output controller 108 determines a rectifying voltage command based on the input power info and the voltage set point. In a case where the available power is sufficient to generate an AC power signal having the desired voltage, the rectifying voltage command can adjust the voltage of the AC power signal when the high DC power signal voltage is not at the desired level or is too high. Although not shown in FIG. 1A, this rectifying voltage command is sent to the output module 114, the output module being adapted to receive the rectifying voltage command and to process the high DC power signal for generating the AC power signal based on the rectifying voltage command.

Further presented in FIG. 1A, the AC power signal is sent to the Interface 106 for further waveform processing and for generating an adjusted AC power signal. The interface 106 verifies if all waveform transferring conditions are met and if this is the case, the Interface 106 then transfers the adjusted AC power signal into the electrical grid 104.

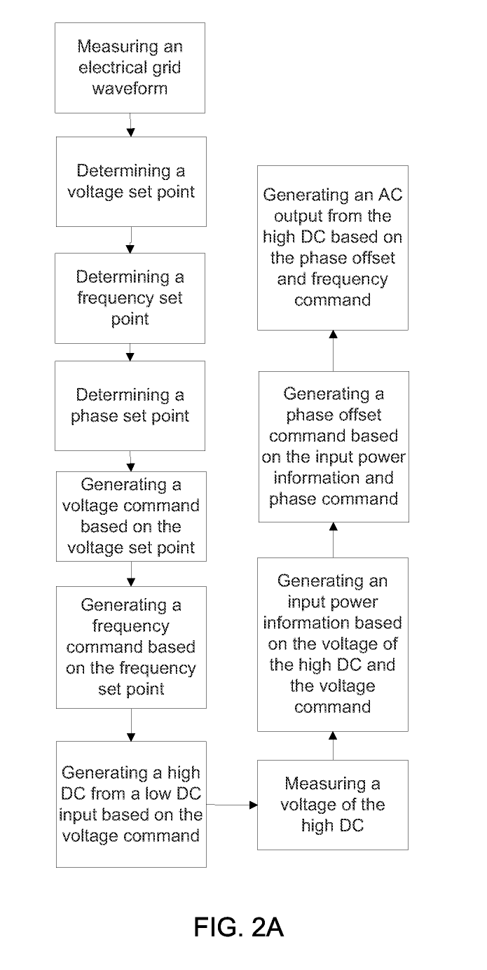

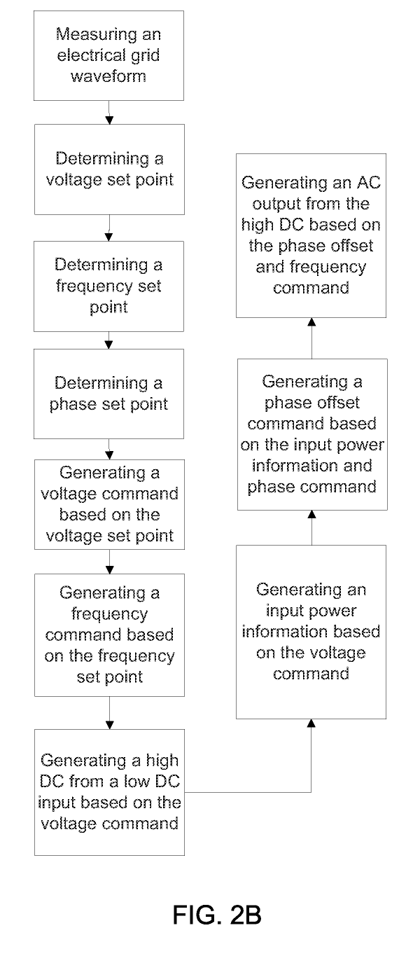

There is presented in FIG. 2A a method for generating the adjusted AC power signal from the variable low DC power signal, the adjusted AC power signal being compatible with the waveform of the electrical grid, according to the system 100 of FIG. 1A.

Presented in FIG. 1B is the system 100 depicted according to another embodiment. In this system 100, the voltage command is a duty cycle command. The input controller 110 generates a pulse width modulation pattern that determines a duty cycle command based on the voltage set point. In this embodiment, the input controller 110 does not need to measure the voltage of the generated high DC power signal to generate the input power info for sending to the output controller 108. Based on the pulse width modulation pattern and the voltage of the low DC power signal, the input controller 110 is adapted to determine the input power info.

There is presented in FIG. 2B a method for generating an adjusted AC power signal from a variable low DC power signal, the adjusted AC power signal being compatible with the waveform of the electrical grid, according to the system 100 of FIG. 1B.

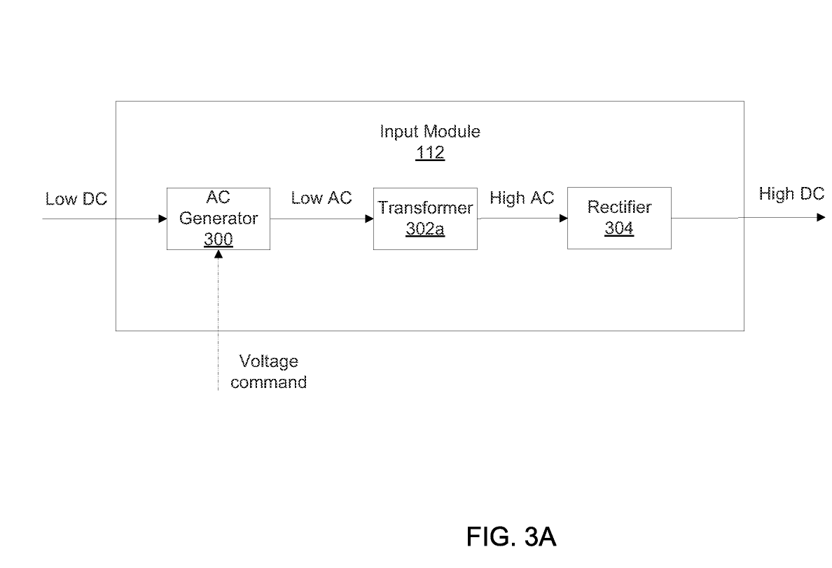

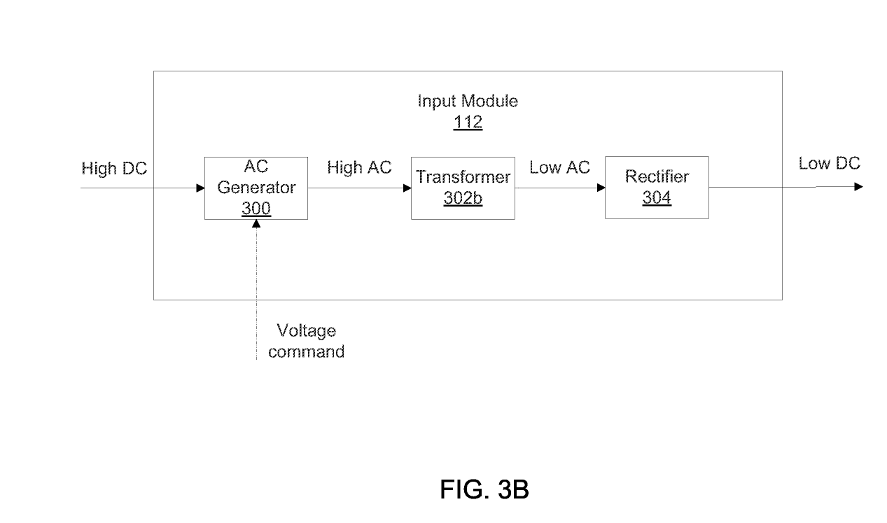

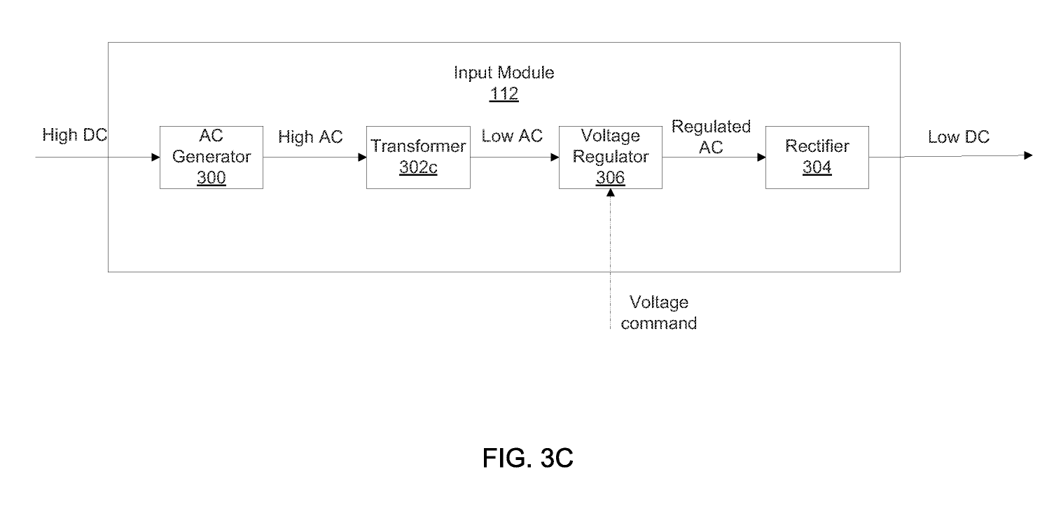

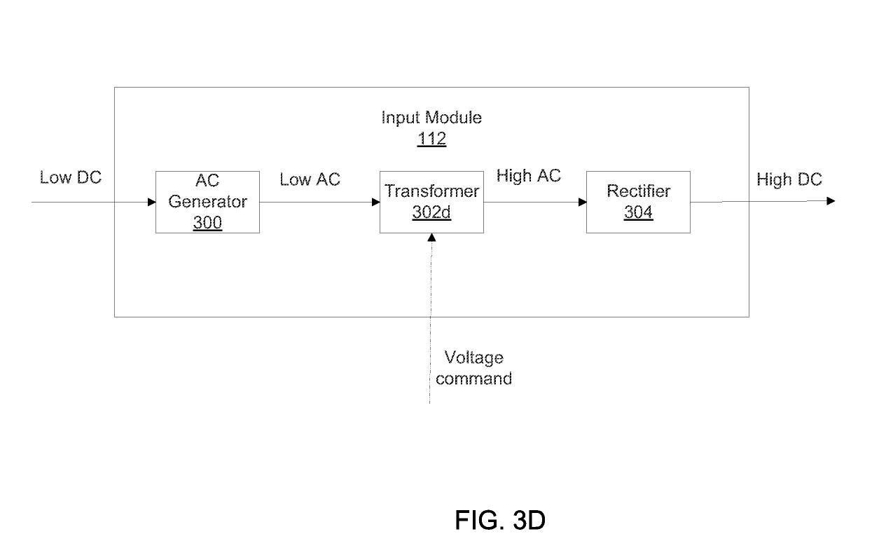

Presented in FIG. 3A is the input module 112, according to an embodiment of the system 100. This input module 112 has an AC generator 300, a transformer 302a and a rectifier 304. The AC generator 300 is adapted to receive the low DC power signal and convert it into a low AC power signal having a voltage that is adapted to the transformer 302a. In one embodiment, the AC generator 300 has a four transistor full-bridge circuit for inverting the low DC power signal to a low AC power signal. The voltage of the low AC power signal is adjusted by the voltage command which controls the four transistor full-bridge circuitry.

The transformer 302a has two secondary windings and increases the voltage of the low AC power signal by a predetermined ratio to generate a high AC power signal.

The rectifier 304 is at least one diode and is connected to the transformer 302a to filter a positive voltage of the high AC power signal and generate the high DC power signal.

Depending on the power source 102, it is possible for the power source 102 to generate a DC having a voltage that is higher than the voltage set point. In such a case, according to yet another embodiment of this system 100, the input module 112 such as presented in FIG. 3B may be used. In this input module 112, a high DC power signal is received by the AC generator 300 a voltage command controls the AC generator 300 for generating a high AC power signal having a voltage that is adapted to the transformer 302b. The transformer 302b then decreases the high AC power signal to a low AC power signal. The low AC power signal is then sent through the rectifier 304 to filter a positive voltage of the low AC power signal and generate a low DC power signal.

According to yet another embodiment of the input module 112, there is presented in FIG. 3C another input module 112 that is adapted to down convert a voltage of a high DC power signal to a low DC power signal. In this input module 112, there is a voltage regulator 306 that is connected to the transformer 302c for regulating the voltage of the low AC power signal based on the voltage command. A skilled reader will understand that this input module 112 can also be used to up convert a voltage of a low DC power signal to a high DC power signal.

According to yet another embodiment of the input module 112, there is presented in FIG. 3D a transformer 302d that is adapted to receive a voltage command. The transformer 302d has multiple secondary windings and allows up converting a voltage of the low AC power signal by various transformation ratios. A selection of the voltage transformation ratio is done by sending the voltage command to the transformer 302d. This can be particularly useful for systems 100 that are adapted to various electrical transportation standards. A skilled reader will understand that the transformer 302d can be of a type that allows down converting a voltage of a high AC power signal by various transformation ratios.

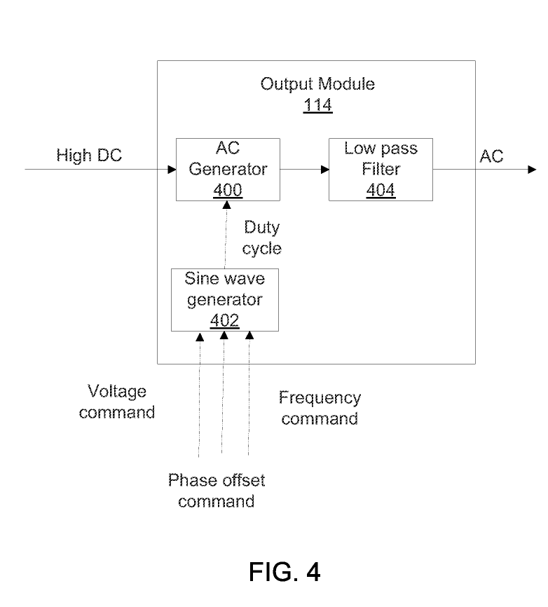

Presented in FIG. 4 there is the output module 114 having an AC generator 400, a sine wave generator 402 and a low pass filter 404. According to an embodiment, the AC generator 400 is an H-bridge inverter and generates an AC power signal from the high DC power signal. The AC generator 400 is commanded by a duty cycle that is controlled by a pulse width modulation generated by the sine wave generator 402. The sine wave generator 402 being controlled by at least one of a voltage command, a phase offset command or a frequency command.

According to yet another embodiment, the low pass filter 404 is connected to the output of the AC generator 400 and removes high frequency components such as harmonics so that only the fundamental component of the AC generator output is transferred to the electrical grid 104.

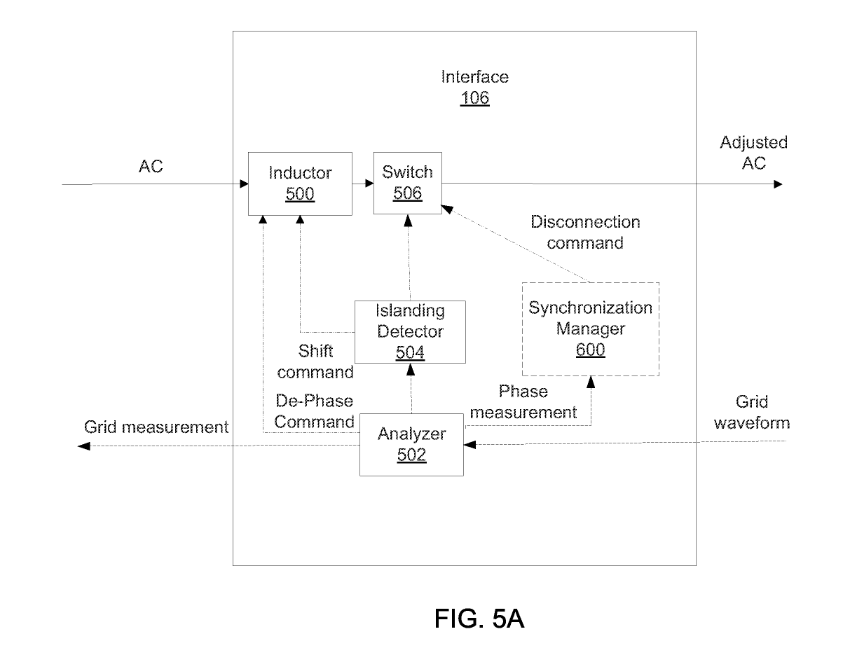

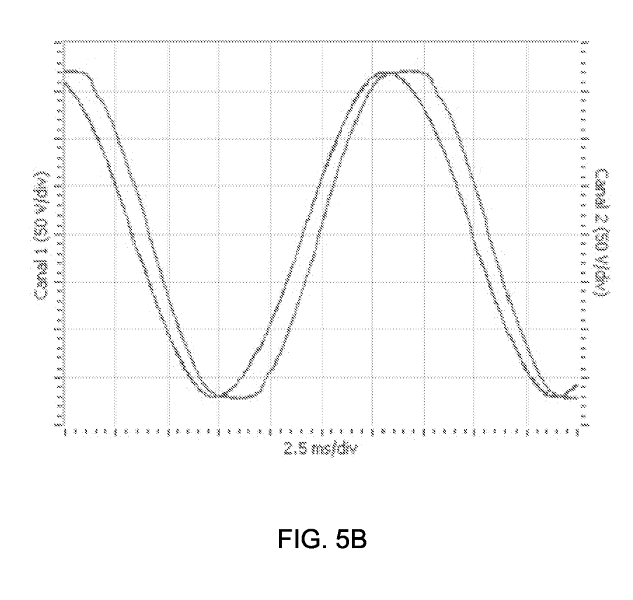

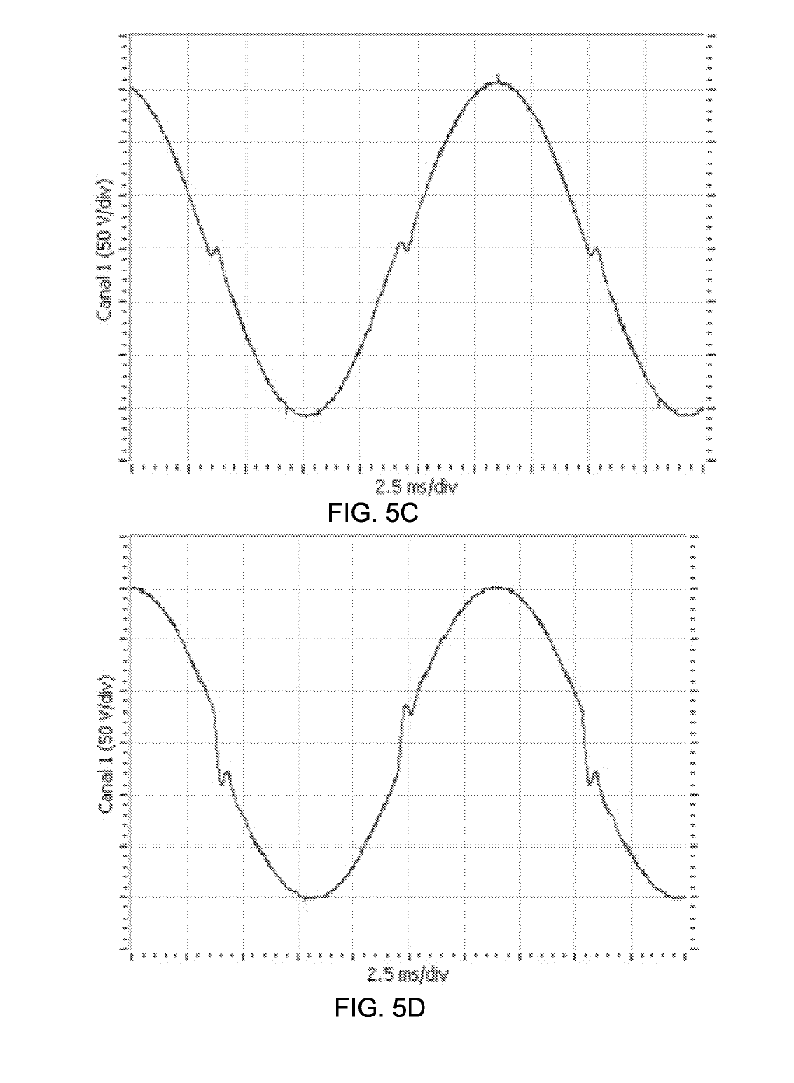

Presented in FIG. 5A, there is the interface 106 having among others an inductor 500 and an analyzer 502. The inductor 500 protects the components of the system 100 against surcharges from the electrical grid 104. Additionally, the inductor 500 introduces a small phase difference between the system's output and the grid's voltage, such as graphically represented in FIG. 5B. This phase difference is necessary to allow the transferring of power into the electrical grid 104. The analyzer 502 analyzes the waveform of the electrical grid 104 and generates the grid measurement. Based on the grid measurement, the analyzer 502 also generates a de-phase command. According to one embodiment, the inductor 500 introduces the small phase difference between the system's output and the grid's voltage based on the de-phase command. It will be understood by a skilled person in the art that the analyzer 502 can be an independent module or part of another module of the system such as the output controller 108 or the output module 114.

Further presented in FIG. 5A, the interface 106 has an islanding detector 504 and a switch 506. The islanding detector 504 is adapted to detect an islanding situation or a loss of the electrical grid based on an analysis of the grid waveform. When an islanding situation is detected, the islanding detector 504 signals a switch 506 to disconnect the system 100 from the electrical grid 104.

An islanding situation can occur when the electrical grid 104 is made un-operational. For example, when a technician wishes to do maintenance work on the electrical grid 104 he will render the electrical grid un-operational producing an electrical blackout. However, he will have no control on the power sources 102 that are connected to the electrical grid 104 and if not disconnected, power from the power sources 102 can still be transferred into the electrical grid 104 and jeopardise his safety. Therefore it is required by various safety standards to automatically disconnect all power sources 102 from the electrical grid 104 when an islanding situation occurs.

The islanding detector 504 is adapted to detect an islanding situation by using one or a combination of islanding detection methods. According to one embodiment the detector 504 is adapted to detect an islanding situation by monitoring the grid voltage and is adapted to signal a disconnection when the measured voltage of the grid 104 is higher or lower than an acceptable range. The acceptable range can be a predetermined range or can be a range that is set through a configuration of the system 100.

According to another embodiment the detector 504 is adapted to detect an islanding situation by monitoring the grid frequency and is adapted to signal a disconnection when the measured frequency of the grid 104 is higher or lower than an acceptable range. The acceptable range can be a predetermined range or can be a range that is set through a configuration of the system 100.

According to another embodiment the detector 504 is adapted to detect an islanding situation by inducing a small perturbation near the zero-crossing of the adjusted AC power signal, such as can be seen in FIG. 5C. A shift command is sent to the inductor 500 for inducing this small perturbation in the voltage of the adjusted AC power signal. This slightly modifies the effective frequency of the adjusted AC power signal. As this perturbation is variable and has a positive feedback, when the grid is present this perturbation cannot be detected and the system operates normally. However, if the grid is not present, the frequency of the grid will be outside of the acceptable range and the islanding detector 504 will then signal a disconnection.

According to yet another embodiment the detector 504 is adapted to detect and islanding situation by inducing a small perturbation of the voltage amplitude of the adjusted AC power signal, such as can be seen in FIG. 5D. A shift command is sent to the inductor 500 for inducing this small perturbation in the voltage amplitude of the adjusted AC power signal. As this perturbation is variable and has a positive feedback, when the grid is present this perturbation cannot be detected and the system operates normally. However, if the grid is not present, the voltage of the grid will be outside of the acceptable range and the islanding detector 504 will then signal a disconnection.

It will be understood by a skilled reader that the shift commands of FIG. 5C or FIG. 5D can be sent to the output controller for having the small perturbation induced by the output module rather than by the inductor 500.

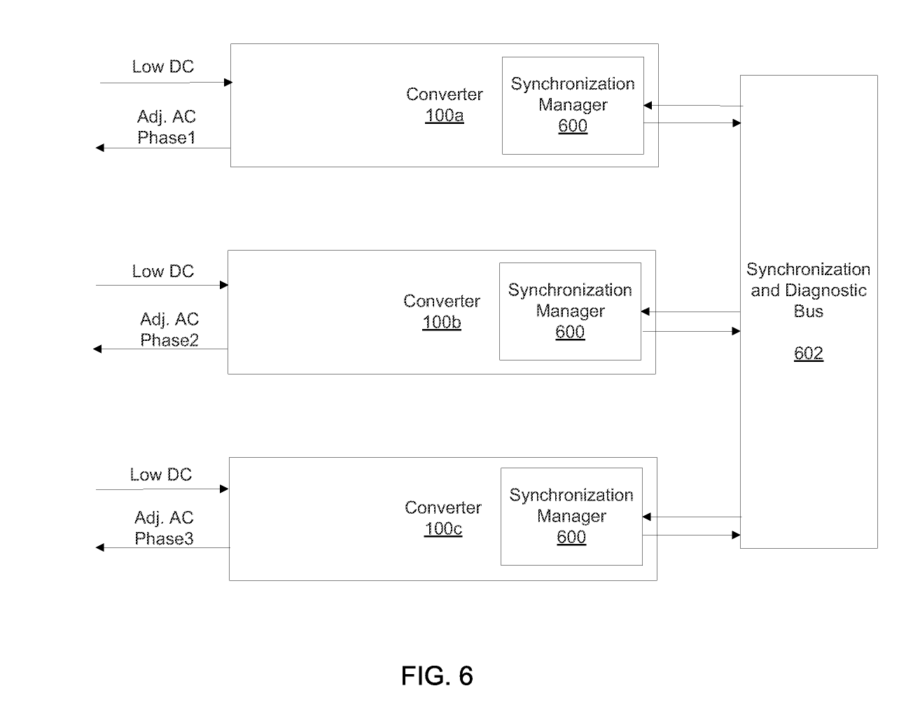

Presented in FIG. 6, three systems 100 are adapted to generate an adjusted AC power signal for each phase of an electrical power line. Each system is connectable to one phase of the electrical power line and is controlled by a synchronization and diagnostic bus 602 for phase integrity purposes. According to an embodiment, the system 100 is adapted to connect to a synchronization and diagnostic bus 602 to which a total of three systems 100 are connectable. The bus 602 has a system connection detector for dynamically detecting a connection of the system 100 to the bus 602 and for dynamically assigning a master or slave function to each connected system 100. According to an embodiment, the connection detector is adapted to assign the master function on a first come first serve basis, the first connected system 100a is assigned the master function and the two other systems (100b and 100c) that are subsequently connected are assigned the slave function. Various other conditions can be used by the connection detector for assigning the master or slave function to each system (100a, 100b and 100c) without departing from the scope of the invention.

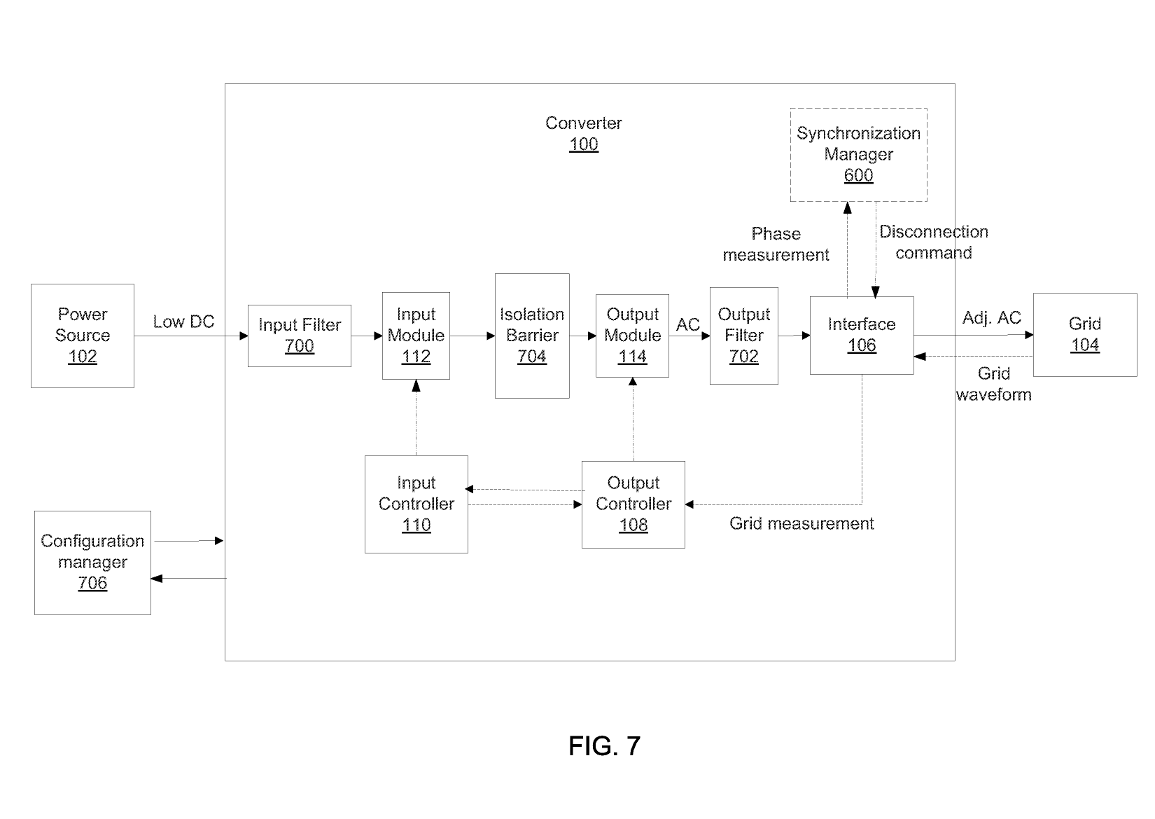

According to an embodiment, each system (100a, 100b and 100c) has a synchronization manager 600 that is the connection point of the system 100 to the bus 602. As presented in FIGS. 5A and 7, the manager 600 is connected to the interface 106 and more specifically to the analyzer 502. As each system (100a, 100b and 100c) adapts to a corresponding phase of the electrical grid 104, the manager 600 of each system (100a, 100b and 100c) sends a phase measurement of the electrical grid 104 to the bus 602. Based on the phase measurement, a phase measurement analyzer of the bus 602 compares the phase measurement of each slave system (100b and 100c) to the phase measurement of the master system 100a. If the phase measurement analyzer detects that a phase delta between the master system 100a and either one of the slave systems (100b and 100c) is outside an acceptable range—typically plus or minus one hundred twenty degrees—a phase abnormality alert is sent by the analyzer to the managers 600 of each system (100a, 100b, 100c). In response, when the manager 600 receives such a phase abnormality alert, it sends a disconnection command to the switch 506. Consequently all three systems (100a, 100b and 100c) are then disconnected.

As further presented in FIG. 7, it will be understood by a skilled reader that the system 100 can comprise other components such as an input filter 700, an output filter 702, an isolation barrier 704, etc.

As even further presented in FIG. 7, the system 100 is adapted to be configured by an electrical line operator through a configuration manager 706 that is connected to the system 100. The configuration manager 706 can be of a type that remains connected to the system 100 while in operation or of a type that is disconnectable from the system 100 once configured. The configuration manager 706 is adapted to allow the operator to set parameters of the system 100. According to one embodiment, the configuration manager is a computerized system that allows the operator to set at least one parameter in at least one of the components of the system 100 such as the interface 106, the output controller 108, the input controller 110, the input module 112, the output module 114, the synchronization manager 600, the input filter 700, the output filter 702 and the isolation barrier 704.

What is claimed is:

1. An electrical power conversion system for connecting an electrical power source to an electrical grid that can draw more electrical power than the electrical power source can provide comprising:
an input module for generating a high voltage DC power signal from a variable low DC power signal of the electrical power source based on a voltage command;
an output module connected to the high voltage DC power signal for generating an AC power signal with a peak voltage based on said voltage command according to a frequency command and a phase command;
an electrical grid interface for selectively connecting said AC power signal to the electrical grid and to measure an electrical grid waveform for generating an electrical grid measurement including voltage, phase and frequency; and
a controller for determining an available power at said low DC power signal to allow said input module to supply said high voltage DC power signal, for setting said phase command with respect to grid phase measured by said electrical grid interface in accordance with said available power, for setting said voltage command based on grid voltage measured by said electrical grid interface, for setting said frequency command based on grid frequency measured by said electrical grid interface and for detecting loss of said electrical grid to control said grid interface to disconnect said AC power signal from said electrical grid.

2. The system of claim 1 wherein said controller comprises an input controller and an output controller, the input controller being for determining said available power at said low DC power signal and for setting said voltage command, the output controller being for setting said phase command, for setting said frequency command and for detecting loss of said electrical grid.

3. The system of claim 1 wherein said controller determines said available power at said low DC power signal based on a voltage measurement of said high voltage DC power signal.

4. The system of claim 1 wherein said controller determines said available power at said low DC power signal based on said voltage command.

5. The system of claim 1 wherein said controller detects said loss of said electrical grid based on more than one islanding detection method.

6. The system of claim 1 further comprising a synchronization manager for connecting to a synchronization bus, for sending to said synchronization bus said grid phase measurement, for receiving a phase abnormality alert from said synchronization bus based in part on said grid phase measurement and for sending a disconnection command in response to said phase abnormality alert.

7. The system of claim 6 wherein said synchronization bus is for diagnosing a phase synchronization between said system and at least one other system based in part on said grid phase measurement.

8. The system of claim 6 wherein said synchronization bus is adapted to dynamically detect a connection of said synchronization manager.

9. The system of claim 6 further comprising a configuration manager interface for setting at least one parameter of at least one of said synchronization manager and said synchronization bus.

10. The system of claim 1 further comprising a configuration manager interface for setting at least one parameter of at least one of said input module, said output module, said electrical grid interface and said controller.
